(19) United States
(12) Patent Application Publication
(10) Pub. No.: US 2004/0157553 A1
(43) Pub. Date: Aug. 12, 2004

(54) Satellite telecommunication method and system and base station for one such system

(76) Inventors: Christophe Levallet, Levallois (FR); Pascal Piau, La Croix Falgarde (FR); Pierre Nyeki, Saint Sulpice (FR); Marie-Noelle Thouvenin, Paris (FR); Guillaume Calot, Le Chesnay (FR); Jean-Francois Ereau, Paris (FR); Regis Laval, Versailles (FR)

Correspondence Address: RATNERPRESTIA, P O BOX 980, VALLEY FORGE, PA, 19482-0980, US

(21) Appl. No.: 10/469,088

(22) PCT Filed: Feb. 7, 2002
(86) PCT No.: PCT/FR02/00476

(30) Foreign Application Priority Data
Feb. 26, 2001 (FR) 0102571

(51) Int. Cl. H04Q 7/20; H04B 7/185

(52) U.S. Cl. 455/12.1; 455/427; 455/429

(57) ABSTRACT

The invention pertains to a method for assigning communication resources in a telecommunication system, in which the communications are relayed by satellites covering an area of land that is divided into zones. Each zone has a communication resource pattern formed, on the one hand, by the directions of the satellites seen from the zones and, on the other hand, by frequency sub-bands and/or polarization. These resources are distributed so that two adjacent zones comprise different resources. The patterns of two zones are distinguished only by the direction of the satellite(s) that are assigned to the zones having this pattern. In one embodiment, all of the frequency resources are assigned to all the zones and the patterns are only distinguished by the directions of the satellites that supply these resources.

The present invention pertains to a telecommunication method and systerm using orbiting satellites or geostationary satellites, as well as to a base station for such a system.

More specifically, it pertains to such a telecommunication system, in which an area of land is divided into zones or cells, each having, e.g., a diameter of several hundreds of kilometers, and each zone has a resource pattern, such that two adjacent zones do not use the same communication resources.

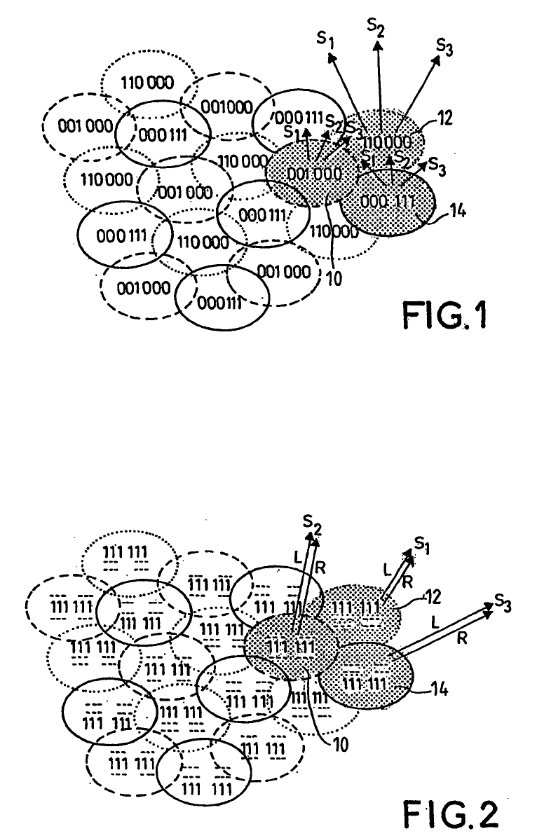

Thus, FIG. 1 shows the zones of a telecommunication system of this type with the pattern of the communication resources that are assigned to this zone inside each zone.

In this system, the zones form groups of three zones 10, 12, 14 that have different patterns. More precisely, different frequency and polarization resources are assigned to zones 10, 12 and 14, and the resource patterns are distributed so that two adjacent zones never have the same resources.

The resources indicated inside each zone have three frequency sub-bands and two polariza-tions. These resources are represented by two groups of three binary numbers, the group on the left representing the left polarization and the group on the right, the right polarization. In each group, a “0” indicates an absence of sub-band and a “1” indicates its presence; thus, the first number on the left corresponds to a first frequency sub-band, the middle number corresponds to the second sub-band and the number on the right corresponds to the sub-band.

For example, the resources 110 000 indicated for the zone 12 mean that the sub-bands No. 1 and No. 2 of the left polarization are assigned to it. The sub-band No. 3 of the left polarization (001 000) is assigned to the zone 10, while the three sub-bands of the right polarization (000 111) are assigned to the zone 14.

FIG. 1 shows that two zones, to which the same frequency and polarization resources are assigned, are always separated by an intermediate zone, to which different resources are assigned.

The resources assigned to each zone are, however, used a plurality of times because the zone is covered by a plurality of satellites. Three satellites S1, S2 and S3 are provided in the example. In other words, the zone 10 calls the sub-band No. 3 of a left polarization three times, once by satellite. Therefore, the communication capacity is multiplied by the number of satellites covering the zones. There can be no interference between communications coming from two different satellites that use the same frequency and polarization resources because the satellites have very distinct directions as seen from the zone. In other words, one resorts to the “spatial diversity” of the satellites to increase the communications capacity.

The satellites are either of the geostationary type, or of the orbiting type. In the latter case, the directions of the satellites S1, S2 and S3 change constantly and, in addition, when a satellite is no longer visible from the zone, it must first be replaced with a visible satellite, the communications relayed by the satellite that disappears from the horizon thus being transferred by the replacement satellite.

Such a system ensures a large communication capacity. However, it has a high cost, namely because of the cost of the equipment onboard each satellite. Thus, in the example shown in FIG. 1, nine antennae or links are needed to cover the cells 10, 12 and 14 in the manner shown in FIG. 1, each satellite having one antenna per zone to be covered.

The present invention makes it possible, for a same communication capacity, to improve the use of the equipment onboard the satellites.

It is characterized in that distinct frequency resources are no longer assigned to each zone, but rather satellites of different directions are assigned thereto. Thus, each zone (or cell) has all the frequency resources, but on only one satellite.

In other words, the communications of two adjacent zones are separated from one another only thanks to the different directions of the satellites. Under these conditions, the total number of antennae needed is reduced. Each satellite must have two antennae for the zone that it must cover. Thus, in total, for three zones and three satellites, the number of antennae or links is six instead of nine, as is described above, for an equivalent number of frequency sub-bands assigned to the three zones.

In the telecommunication system according to the present invention, the resources can be uniformly distributed over various zones. Therefore, the management of the system is simplified.

In addition, one satellite only being assigned to a single zone among a plurality of adjacent zones, the frequency sub-bands or other resources used are able to be processed independently of one another between two zones. For example, the distribution of each sub-band between the going path and the return path may be different from one zone to another. It is recalled that the going path is that of the base station toward the terminals and that the return path is from each terminal toward the base station.

For a given constellation of satellites the telecommunication system according to the present invention can be used for all the zones or only for some of them, the resources being distributed in a conventional manner, as described, for example, in relation to FIG. 1 for these other resources.

The present invention pertains not only to a method for assigning resources to various zones, this assignment being generally carried out from a control center of the telecommunication system, but also the equipment of the base stations that are suited to receive all the resources assigned to the system, or a large part of these resources, and whose antennae are pointed toward only one satellite or the satellites used only for this zone and not the other zones of the same system.

Briefly, the present invention pertains to a method for assigning communication resources in a telecommunication system in which the communications are relayed by satellites covering an area of land that is divided into zones, each zone having a pattern of communication resources formed, on the one hand, by the directions of the satellites seen from the zones and, on the other hand, by the frequency sdb-bands and/or polarization, with these resources being distributed so that two adjacent zones have different resources. This method is such that the patterns of two zones are distinguished only by the direction of the satellite(s) assigned to the zones of this pattern.

In one embodiment, only one satellite is assigned to each zone.

In a variant, a plurality of satellites are assigned to one zone, these satellites not being used for the adjacent zones.

Preferably, all of the frequency resources are assigned to all the zones, with the patterns only being distinguished by the directions of the satellites that supply these resources.

According to an embodiment for a part of the area of land covered by the telecommunication system the patterns of two zones are only distinguished by the directions of the satellites with which they communicate, while the patterns of two zones are distinguished by other resources, such as the frequency and/or the polarization, for other parts of the area of land.

The same frequency sub-band may be assigned in two adjacent zones, and this sub-band is divided into two parts, one for the going path and the other for the return path, and this division is different between the first and second zones.

The present invention also pertains to a telecommunication system base station, in which the communications are relayed by the satellites covering an area of land that is divided into zones, the communication resources comprising, on the one hand, the directions of the satellites seen from the zones and, on the other hand, the frequency sub-bands and/or polarization, and these resources are distributed so that two adjacent zones are distinguished by at least one of the resources. This station is such that it has means for pointing toward at least one satellite, the direction of pointing being different from the direction of pointing for a base station of an adjacent zone.

Preferably, the base station has means for receiving all the communication resources, other than the directions of the satellites that are assigned to the system.

Other characteristics and advantages of the present invention shall become evident with the description of some of its embodiments, provided with reference to the attached drawings, in which:

FIG. 1, already described, shows a classical type telecommunication system,

FIG. 2 is a diagram similar to the one in FIG. 1, showing a telecommunication system according to the present invention,

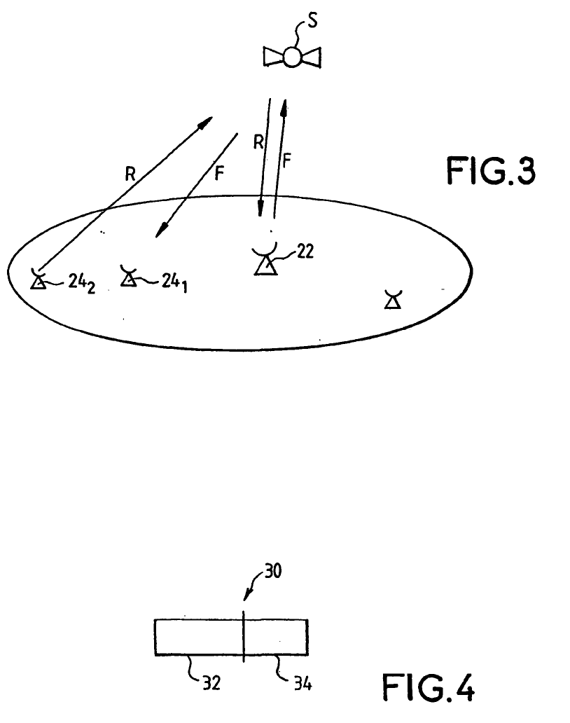

FIG. 3 is a diagram showing a zone or cell with a base station, terminals and a satellite, and

FIG. 4 is a diagram showing the distribution of the resources in a frequency sub-band.

In the example shown in FIG. 2, which is similar to the one shown in FIG. 1, as concerns the number of available resources and the zones 10, 12, 14, all the available resources are assigned to each zone, i.e., the three sub-bands with the right polarization and the left polarization. Thus, the resources 111 are indicated in each zone 10, 12, 14.

However, to prevent interferences between zones having an identical pattern, in the example only one satellite is assigned to each zone. This is the reason why, three lines are shown inside each zone in the diagram in FIG. 2, the first line corresponding to the satellite S1, the second line to the satellite S2 and the third line to the satellite S3. Thus, for the zone 10, to which the satellite S2 is assigned, only the second line is full.

For the equipment to be provided in each zone, namely in the base station, it is sufficient to provide one antenna for the left polarization (L) and one antenna for the right polarization (R), i.e., six antennae in all for all of the three zones, while in the conventional telecommunication system as described in relation to FIG. 1, it was necessary to provide a total of nine antennae for the same number of satellites and the same pattern.

The present invention is not, of course, limited to the example described, in which the zones or cells form groups of three elements. The number of elements of each group may be any number.

As concerns the number of satellites, it must permanently be at least equal to the number of geometric resources provided in the patterns, a geometric resource being a direction of a satellite It may be higher, however. For example, it is possible to plan on assigning a couple of satellites to a zone, provided that the angular direction of this couple of satellites is very distinct from the angular directions of the satellites assigned to the adjacent zones.

Even though it is preferable to assign all the resources to each zone in order to maximize the communication capacity, it is possible, however, to assign only a part thereof in some cases.

Moreover, in a telecommunication system covering an area of land, it is possible to use the system of distribution of resources according to the present invention as shown in FIG. 2 for a part of the area of land and, for one or more other parts of the area of land, the classical type of method of distribution shown in FIG. 1 can be used.

Besides a better use of the equipment onboard the satellites, the present invention makes it possible to homogenize the assignment of the resources in the different cells. In fact, if the example of FIG. 2 is compared with that shown in FIG. 1, it is seen that in the example of FIG. 1 which corresponds to a classical system, three resources (1 sub-band on 3 satellites) are assigned to the zone 10, six resources (2 sub-bands on 3 satellites) are assigned to the zone 12 and nine resources (3 sub-bands on 3 satellites) are assigned to the zone 14, while in the system according to the present invention, six resources (6 sub-bands on 1 satellite) are assigned to each of the zones. The present invention is thus well suited to zones with homogenous traffic.

The present invention also makes possible a greater flexibility in each sub-band. In fact, the frequencies of each sub-band can be distributed between the going path and the return path and this independently from one cell to another because all the resources are available on the zone, contrary to a classical system.

Even though the notions of going path and return path are classical in a telecommunication system, the meanings of these terms are recalled here. As is shown in FIG. 3, a base station 22 is provided in each zone 20, which communicates, by means of a satellite S, with all of the terminals 24₁, 24₂, etc. located in this same zone 20. The going path (arrow f [sic, F]) is the path that leaves the base station 22 to end up at the terminals 24ᵢ by passing through the satellite S. The return path (arrow R) is that which leaves a terminal to end up at the base station 22.

As shown in FIG. 4, each frequency sub-band is divided into two parts 32 and 34, and the first part 32 is assigned to the going path and the second part 34 is assigned to the return path. The two parts are not generally equal because the traffics are not the same. For example, it is known that for Internet traffic, the going path corresponds to a traffic that is clearly superior to the return path. In fact, in the return path, especially questions or queries circulate towards sites, while, in the going path, a greater traffic is transmitted, such as program downloads or other data. On the other hand, for other applications, the traffics of the going and return paths may be practically the same: For example, telephone conversations or video conferences. Thus, the traffics on the going and return paths may be different from one zone to another, and the present invention makes it possible to separate the sub-band into two parts, which may be different from one zone to another.

The various parameters of the telecommunication system are controlled from a centralized control center (not shown), in which a control device is installed for assigning the resources. Thus, the method according to the present invention is mainly used in this control center.

The method according to the present invention is also used in the base stations and in the terminals. In particular, each base station 22 must have one antenna pointed towards a satellite and have means for receiving all of the communication resources or a large part of the communication resources.

1. Method for assigning communication resources in a telecommunication system, in which the communications are relayed by satellites (S1, S2, S3) covering an area of land which is divided into said zones (10, 12, 14), each zone having a pattern of communication resources formed, on the one hand, by the directions of the satellites as seen from the zones and, on the other hand, by at least one of the sub-band frequencies and polarization, these resources being distributed so that two adjacent zones have different resources, characterized in that the patterns of two zones are distinguished only by the direction of the satellite(s) assigned to the zones having this pattern.

2. Method in accordance with claim 1, characterized in that only one satellite is assigned to each zone.

3. Method in accordance with claim 1, characterized in that a plurality of satellites are assigned to a zone, these satellites not being used for the adjacent zones.

4. Method in accordance with claim 1, 2 or 3, characterized in that all the frequency resources (111 111) are assigned to all the zones, with the patterns being distinguished only by the directions of the satellites that supply these resources.

5. Method in accordance with any of the claims 1 through 4, characterized in that for a part of the area of land covered by the telecommunication system, the patterns of two zones are only distinguished by the directions of the satellites with which they communicate,. while for other parts of the area of land, the patterns of two zones are distinguished by other resources, such as the frequency and/or the polarization.

6. Method in accordance with any of the above claims, characterized in that in two adjacent zones, the same frequency sub-band is assigned, this sub-band being divided into two parts, one for the going path and the other for the return path, and in that the division is different between the first and the second zones.

7. Application of the method in accordance with any of the above claims to a telecommunica-tion system with geostationary satellites.

8. Application of the method in accordance with any of the claims 1 through 6 to a telecommunication system with orbiting satellites.

9. Base station (22) for telecommunication system in which the communications are relayed by satellites covering an area of land that is divided into zones, the communication resources comprising, on the one hand, the directions of the satellites as seen from the zones and, on the other hand, at least one of sub-band frequencies and polarization, with these resources being distributed so that two adjacent zones are distinguished by at least one of the resources, characterized in that it has means for pointing towards at least one satellite, the direction of pointing being different from the direction of pointing for a base station of an adjacent zone.

10. Base station in accordance with claim 9, characterized by means for receiving all of the communication resources, other than the directions of the satellites that are assigned to the system.
